(19) United States
(12) Patent Application Publication
(10) Pub. No.: US 2016/0153412 A1
(43) Pub. Date: Jun. 2, 2016

(54) FUEL INJECTOR

(71) Applicant: DELPHI INTERNATIONAL OPERATIONS LUXEMBOURG S.À R.L., Bascharage (LU)

(72) Inventor: THIERRY THIBAULT, SAINT OUEN LES VIGNES (FR)

(21) Appl. No.: 14/906,635

(22) PCT Filed: Jul. 21, 2014
(86) PCT No.: PCT/EP2014/065637

§ 371 Date: Jan. 21, 2016

(30) Foreign Application Priority Data
Jul. 23, 2013 (EP) 13177670.0

(51) Int. Cl. F02M 51/06

(52) U.S. Cl. CPC F02M 51/061

(57) ABSTRACT

A pressurized fuel injector includes a tubular body which forms a nozzle at one end such that fuel flows in the body between an inlet and the nozzle. A needle is arranged in the body and moves between an open nozzle position and a closed nozzle position, the fuel circulating in a space between the needle and the inner surface of the body, the needle being controlled according to a difference in pressure between a first control chamber into which the upstream end of the needle opens and the nozzle which is located downstream, the pressure in the first control chamber being regulated by a control valve operated by an electromagnet. The injector is provided with a complementary means for controlling the needle, the means engaging with the first control chamber such that the pressure of the fuel at the inlet is entirely transmitted to the injection nozzle.

### CROSS REFERENCE TO RELATED APPLICATIONS

This application is a national stage application under 35 USC 371 of PCT Application No. PCT/EP2014/065637 having an international filing date of Jul. 21, 2014, which is designated in the United States and which claimed the benefit of EP Patent Application No. 13177670.0 filed on Jul. 23, 2013, the entire disclosures each are hereby incorporated by reference in their entirety.

### TECHNICAL FIELD

The present invention relates to a fuel injector for vehicle engines. It particularly relates to the control system of the injector.

### TECHNOLOGICAL BACKGROUND TO THE INVENTION

Fuel injectors are provided with a needle moving in a tubular body. The movements of the needle depend on a pressure difference between an upstream control chamber and the downstream nozzle. The fuel flows in the body from an inlet to the injection nozzle. The fuel particularly passes through a restriction which creates a drop in pressure, such that the fuel injected through the nozzle is lower than that arriving at the inlet. The difference is in the order of 200 bars. The application EP 12152743 filed on Jan. 26, 2012 is known about.

### SUMMARY OF THE INVENTION

The present invention aims to solve these problems by proposing a pressurized fuel injector comprising a tubular body which extends along a longitudinal axis and forms a nozzle at one end. The fuel flows in the body between an inlet and the nozzle, likewise comprising a needle arranged axially in the body and being capable of moving between an open nozzle position and a closed nozzle position, said fuel circulating in the space between the needle and the inner surface of the body. The needle is controlled according to a difference in pressure between a first control chamber into which the upstream end of the needle opens and the nozzle which is located downstream, the pressure in the first control chamber being regulated by a control valve operated by an electromagnet. The injector is, moreover, provided with a complementary means for controlling the needle, said means engaging with the first control chamber such that the pressure of the fuel at the inlet is entirely transmitted to the injection nozzle.

The complementary control means comprises a second control chamber arranged in the needle and connected to said space by a calibrated aperture. The needle is moreover provided with an axial blind bore opening out into the upstream end of the needle, the bore forming the second control chamber.

Moreover, the complementary control means further comprises a closing member integral with the body and arranged in such a manner as to close the upstream portion of the second control chamber.

The closing member is likewise a cylindrical piston, the cross section whereof is slidingly adjusted to that of the needle bore, the cylindrical piston bearing against a wall of the first control chamber.

Moreover, the complementary control means further comprises a filling channel for the second control chamber and another passive valve opening or closing said filling channel.

Moreover, said other passive valve comprises a flexible member permanently stressing a closing member against a seat enclosing the opening of the filling channel in the second control chamber.

Moreover, the pressurized fuel injection method comprises the stages:
provision of an injector and activation of the control valve, such that the pressure in the first control chamber develops to move the needle,
activation of the complementary control means helping to move the needle, the pressure at the nozzle being identical to the pressure at the inlet.

Moreover, the needle is moved towards the closed nozzle position of the injector, the activation stage comprising the following stages:
closure of the control valve and filling of the first control chamber and the second control chamber, the fuel flowing quickly through the aperture of the filling channel and moving said other control valve in such a manner that the pressure in the second control chamber is identical to the pressure at the inlet and the cylindrical piston remains supported against a wall of the first control chamber, the needle being in the closed nozzle position as quickly as possible.

In addition to the procedure in which the needle is moved towards the open nozzle position, the activation stage comprising the following stages:
the opening of the control valve, the depression created initiating the movement of the needle, the fuel trapped in the second control chamber escaping through the calibrated aperture in such a manner that the opening speed of the nozzle is controlled by it, the pressure of the fuel injected through the nozzle being equal to the pressure at the inlet.

Moreover, an injector characterized in that the calibration of the spring is sufficiently weak to allow the ball to be sealed on its seat.

### BRIEF DESCRIPTION OF THE DRAWING

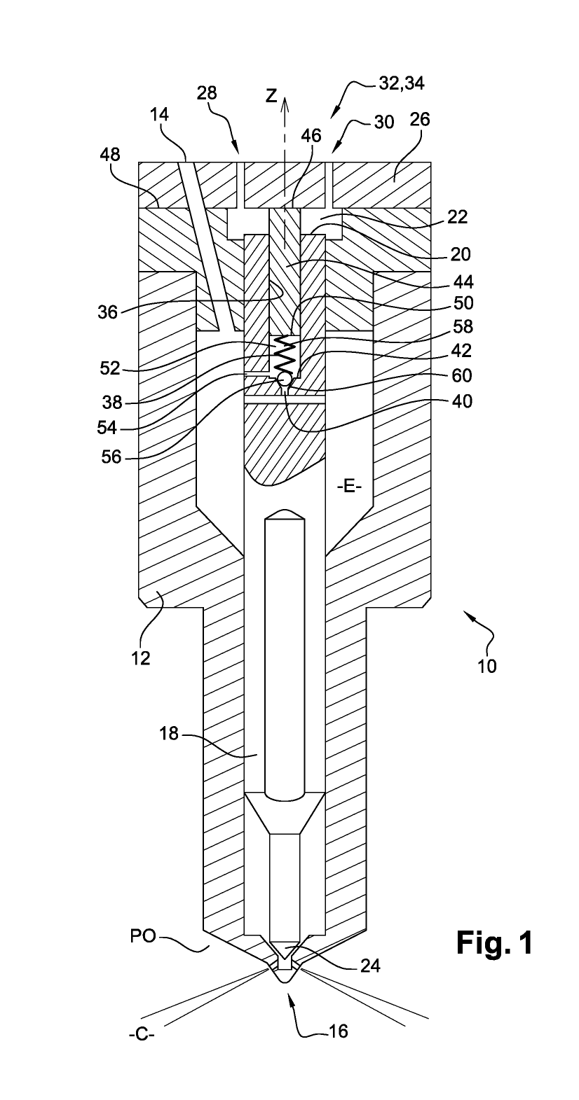

Other characteristics, aims and advantages of the invention will emerge on reading the detailed description which follows and observing the attached FIG. 1, provided by way of a non-limiting example and representing an axial sectional diagram of an injector according to the invention.

### DESCRIPTION OF PREFERRED EMBODIMENTS

An embodiment of an injector is now described with reference to FIG. 1.

In order to make the description clearer and more succinct, a top-to-bottom orientation will be used according to the direction of the figure, without there being any intention to thereby limit the scope of protection, particularly with regard to the different installations of an injector in a vehicle. Words such as “top, bottom, below, above, vertical, raise, lower . . . ” will be used without limiting intent.

An internal combustion engine (not shown) comprises an injection system provided with one or a plurality of injectors 10 which extend along a longitudinal axis Z. The injector is provided with a tubular body 12 defining an internal space E in which pressurized fuel C circulates between an upstream inlet 14 and an injection nozzle 16 forming the downstream point of the body 12.

Arranged longitudinally Z in the body 12 is a needle 18 capable of sliding between an open nozzle PO, needle “up” in the direction of the figure, and a closed nozzle position PF, needle “down”.

The needle 18 extends from an upstream end 20 opening out into a control chamber 22 to a downstream end 24 in the nozzle 16. The control chamber 22 is realized in thick sheet metal 26 integral with the body 12, the fuel arriving there through a first channel 28 and leaving through a control channel 30, the opening and closing whereof are controlled by a control valve 32 operated by an electromagnet 34.

The needle 18 is provided with an axial blind bore 36 which only opens out through the upstream end 20 of the needle 18. A calibrated aperture 38 with a small cross section extends radially below the bore 36. The aperture 38 crosses the needle 18 from the bore 36 until it opens out in the space E. The bore 36 is likewise in fluidic communication with the space E by means of a filling channel 40 of the bore 36. The channel 40 with a large cross section extends from the base 42 of the bore 36 to the outer wall of the needle. As can be seen in the figure, the channel 40 comprises an axial portion connected to the centre of a radial passage opening out on either side of the needle. Other embodiments are of course possible, for example a single bias section.

A piston 44 which is in the shape of a revolving cylinder, the upper end 46 whereof rests against the transverse wall 48 of the thick sheet metal 26, is arranged axially Z in the bore 36 forming, in the manner illustrated, as can be seen in FIG. 1, the “ceiling” of the control chamber 22. The piston 44 extends in the bore 36 as far as a lower end 50 distal from the base 42 of the bore 36. The bore space situated below the piston 44 forms a second control chamber 52 in which the calibrated aperture 38 and the filling channel 40 open out.

A passive valve 54 comprising a ball 56 permanently stressed by a spring 58 against a seat 60 formed at the base 42 of the bore 36 and enclosing the arrival of the filling channel 40 is arranged in the second control chamber 52. The spring 58 is compressed between the ball 56 and the lower end 50 of the piston 44. Numerous structural alternatives of passive valves exist, particularly by replacing the ball with another closing member such as a flat end fixed to the end of the spring. The geometry of the valve seat is then selected to complement that of the closing member.

The operation of the injector is now described. The injector 10 in FIG. 1 is depicted in the open nozzle position PO, the needle being up, the fuel C leaving through the nozzle 16 at the same pressure as that which arrives at the inlet, meaning that there is no loss of pressure during the crossing on the inside of the injector 10. The control valve 32 is activated and the control channel 30 is open, allowing the fuel to leave, the pressure in the control chamber having dropped greatly so that the pressure in the nozzle 16 prevails. The pressure of the fuel at the nozzle applies an axial force F1 to the needle directed upwards, such that the needle 18 is kept “up”. The piston 44 is supported against the ceiling of the control chamber 22; the volume of the second control chamber 52 is therefore minimized. The ball 56 stressed by the spring 58 closes the filling channel 40.

The transitional phase of the open nozzle position towards the closed nozzle position will now be described. From the open nozzle position, the control valve 32 is activated to close the control channel 30. From this moment, the pressurized fuel C enters through the first channel 28 into the control chamber 22, now referred to as the first control chamber 22, and into the second control chamber 52 through the calibrated aperture 38 and through the filling channel 40. The pressure in the chamber 22 increases greatly until it reaches the entry pressure 14 level. The pressurized fuel in the first control chamber 22 and the second control chamber 52 exerts a force on the axial end 20 of the needle oriented towards the nozzle. The pressure in the second control chamber 52 is equal to the pressure at the entry to the injector. This force F2 initiates the movement of the needle 18 as the pressure is exerted upstream of the needle; added to this is the force F3 exerted in the second control chamber 52 oriented downwards. The sum of the two forces F2 and F3 opposes the force F1 which is exerted on the downstream end of the needle and oriented upwards. The sum of the forces F2 and F3 is greater than the force F1 and the needle therefore drops. In this downward movement of the needle 18, the volume of the second control chamber increases, creating a pressure drop. In order to avoid this phenomenon, the ball 56 moves away from the seat 60, such that the pressurized fuel C easily enters the second control chamber through the filling channel 40 which is now open. The downward movement of the needle 18 is accelerated by this until the needle 18 is in abutment in the closed nozzle position PF.

The closed nozzle position PF will now be described. The control channel 30 is always closed and the pressure in the control chamber 22 is at the entry pressure. The piston 44 always rests against the ceiling of the first control chamber 22 and the needle 18 is down in the closed nozzle position, so the volume of the second control chamber 52 is now maximized. The ball 56 has been replaced against the seat 60, closing the filling channel 40. The pressure in the second control chamber 52 is then identical to the entry pressure.

The transitional phase from the closed nozzle position towards the open nozzle position will now be described. From the closed nozzle position PF, the control valve 32 is activated to open the control channel 30. The fuel C, being able to escape from the first control chamber 22, therefore reduces the pressure there. The needle 18 is now only subject to the axial force F1 directed upwards and to the pressure of the fuel at the nozzle 16, said force F1 prevails broadly over a small opposing force F3 exerted by the captive fuel in the second control chamber 52 and holding the ball 56 against the seat 60, hence the needle 18 moves upwards. In this movement, the volume of the second control chamber 52 drops and the fuel C escapes from it through the calibrated aperture 38. The output rate of the fuel is limited by the small cross section of the calibrated aperture 38, thereby limiting the speed at which the needle 18 rises again. The needle 18 moves until it is in the upper position, as previously described. The role of the calibrated aperture 38 therefore clearly appears to be one of speeding up the rising of the needle 18. In this role, an alternative design could replace the calibrated aperture 38 with any other valve solution. It likewise appears that the piston 44 is in permanent contact with the thick sheet metal 26 and could be fixed to or else integral therewith. However, as can be seen in the figure, a piston fixed to the sheet metal would create a hyperstatic axial guide of the needle already guided in the body in the lower section. It is therefore interesting for the piston 44 to retain a degree of transverse freedom.

1. (canceled)

2. The injector as claimed in claim 9, in which the closing member is a cylindrical piston, the cross section whereof is slidingly adjusted to that of the needle bore, the cylindrical piston resting against a wall of the first control chamber.

3. The injector as claimed in claim 9, in which the complementary control means further comprises a filling channel for the second control chamber and passive valve opening or closing said filling channel.

4. The injector as claimed in claim 3, in which said passive valve comprises a flexible member permanently stressing a closing member against a seat enclosing the opening of the filling channel in the second control chamber.

5. An injector as indicated in claim 4, wherein the flexible member is a spring, the calibration of said spring being sufficiently weak to allow the ball to be sealed on its seat.

6-8. (canceled)

9. A pressurized fuel injector comprising:
a tubular body which extends along a longitudinal axis and forms a nozzle at one end such that fuel flows in the body between an inlet and the nozzle;
a needle arranged axially in the body and moving between an open nozzle position and a closed nozzle position, said fuel circulating in a space between the needle and an inner surface of the body, the needle being controlled according to a difference in pressure between a first control chamber into which an upstream end of the needle opens and the nozzle which is located downstream, the pressure in the first control chamber being regulated by a control valve operated by an electromagnet; and
a complementary means for controlling which engages with the first control chamber such that the pressure of the fuel at the inlet is entirely transmitted to the injection nozzle, the complementary means for controlling comprising:
a second control chamber arranged in the needle and connected to said space by a calibrated aperture; and
a closing member integral with the body and arranged in such a manner as to close an upstream portion of the second control chamber,
wherein the needle is provided with an axial blind bore opening out into the upstream end of the needle, the bore forming the second control chamber.

10. The injector as claimed in claim 2, in which the complementary control means further comprises a filling channel for the second control chamber and another passive valve opening or closing said filling channel.

11. The injector as claimed in claim 10, in which said other passive valve comprises a flexible member permanently stressing a closing member against a seat enclosing the opening of the filling channel in the second control chamber.

12. An injector as indicated in claim 11, characterized in that the flexible member is a spring, the calibration of said spring being sufficiently weak to allow the ball to be sealed on its seat.

13. A method of operating a fuel injector having a tubular body which extends along a longitudinal axis and forms a nozzle at one end such that fuel flows in the body between an inlet and the nozzle; a needle arranged axially in the body and moving between an open nozzle position and a closed nozzle position, said fuel circulating in a space between the needle and an inner surface of the body, the needle being controlled according to a difference in pressure between a first control chamber into which an upstream end of the needle opens and the nozzle which is located downstream, the pressure in the first control chamber being regulated by a control valve operated by an electromagnet; and a complementary means for controlling which engages with the first control chamber such that the pressure of the fuel at the inlet is entirely transmitted to the injection nozzle, the complementary means for controlling including a second control chamber arranged in the needle and connected to said space by a calibrated aperture and a closing member integral with the body and arranged in such a manner as to close an upstream portion of the second control chamber, wherein the needle is provided with an axial blind bore opening out into the upstream end of the needle, the bore forming the second control chamber such that pressure in the first control chamber develops in order to move the needle, said method comprising:
activation of the complimentary control means helping to move the needle, the pressure at the nozzle being identical to the pressure at the inlet.

14. The method as claimed in claim 13, wherein the closing member is a cylindrical piston, the cross section whereof is slidingly adjusted to that of the needle bore, the cylindrical piston resting against a wall of the first control chamber, the complementary control means further comprising a filling channel for the second control chamber and a passive valve opening or closing said filling channel, said passive valve comprises a flexible member permanently stressing a closing member against a seat enclosing the opening of the filling channel in the second control chamber; said method further comprising:
closing the control valve, thereby filling the first control chamber and the second control chamber, the fuel flowing through the filling channel and moving said other control valve in such a manner that the pressure in the second control chamber is identical to the pressure at the inlet and the cylindrical piston remains supported against a wall of the first control chamber, and as a result, moving the needle to the closed nozzle position.

15. The method as claimed in claim 13, wherein the closing member is a cylindrical piston, the cross section whereof is slidingly adjusted to that of the needle bore, the cylindrical piston resting against a wall of the first control chamber, the complementary control means further comprising a filling channel for the second control chamber and a passive valve opening or closing said filling channel, said passive valve comprises a flexible member permanently stressing a closing member against a seat enclosing the opening of the filling channel in the second control chamber; said method further comprising:
opening the control valve, thereby creating a depression which initiates movement of the needle toward the open nozzle position, the fuel trapped in the second control chamber escaping through the calibrated aperture in such a manner that the opening speed is controlled by it, the pressure of the fuel injected through the nozzle being equal to the pressure at the inlet.
